(19) United States
(12) Patent Application Publication
(10) Pub. No.: US 2007/0136814 A1
(43) Pub. Date: Jun. 14, 2007

(54) Critical function monitoring and compliance auditing system

(76) Inventors: Michael Lee, Thousand Oaks, CA (US); Bruce Hatfax, Dana Point, CA (US); Jeffrey Wingad, Sandy, UT (US)

Correspondence Address: Michael Lee, Suite 405, 1534 N. Moorpark Road, Thousand Oaks, CA, 91360-5129, US

(21) Appl. No.: 11/299,049

(22) Filed: Dec. 12, 2005

(51) Int. Cl. H04L 9/00; G06F 12/14; G06F 11/00; H04L 9/32; G06F 17/00; G06F 11/30; H04K 1/00; G06F 12/16; G06F 15/18; G08B 23/00

(52) U.S. Cl. 726/25; 726/24; 713/188; 726/1

(57) ABSTRACT

A system and method for monitoring, auditing and flagging compliance issues or other user defined exceptions with user defined systems for internal monitoring of adherence to critical functions and operations or systems such as ISO-9000 and other government mandated requirements such as HIPPA and other mandated security provisions as defined in federal and state legislative acts and derivative rules as defined by government agencies under authority of such legislative acts.

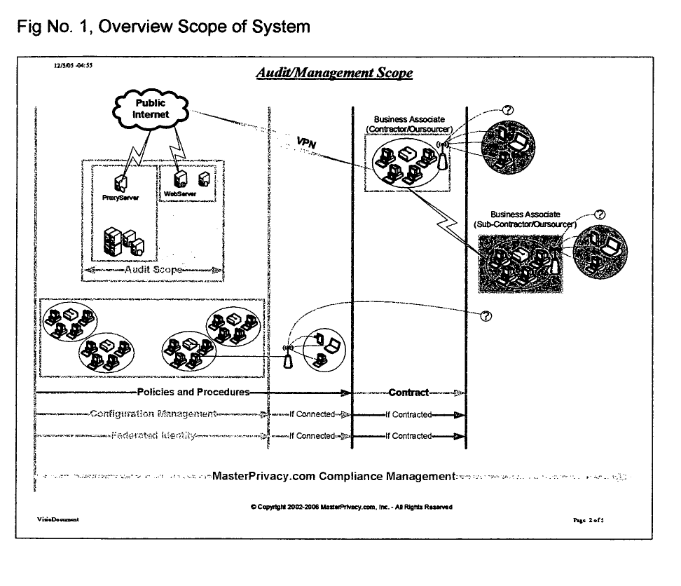

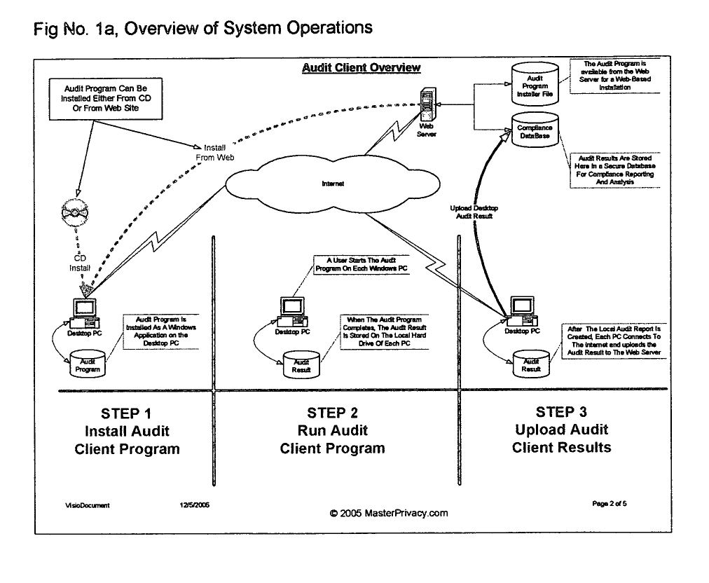

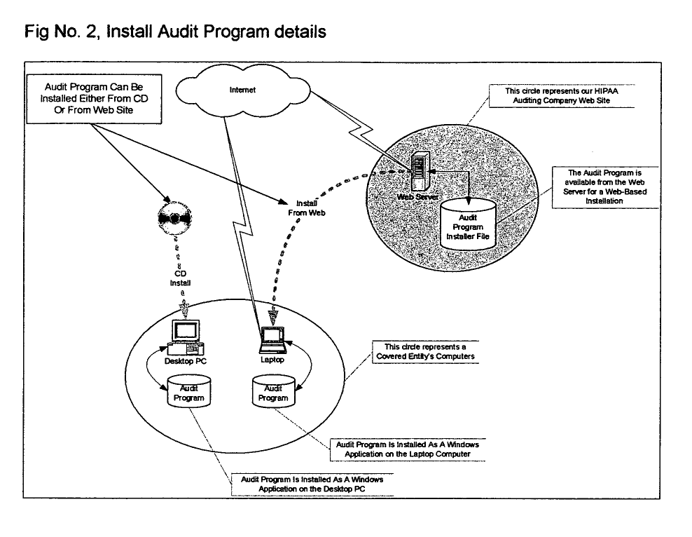

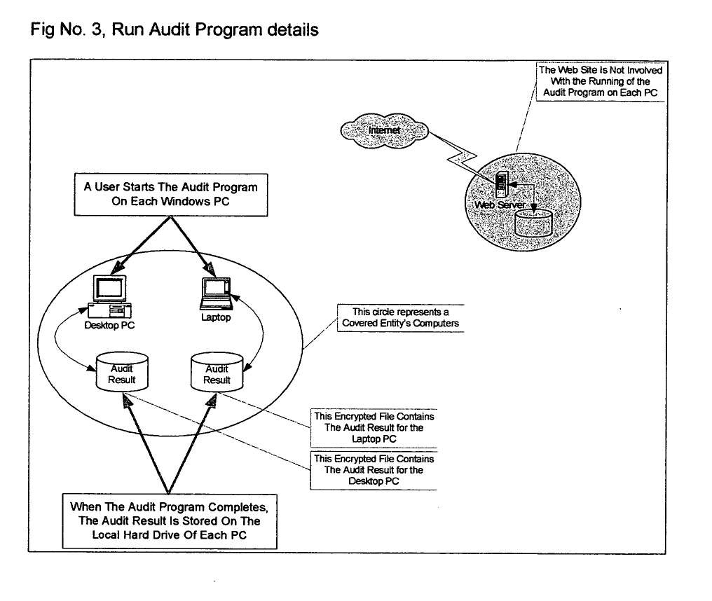

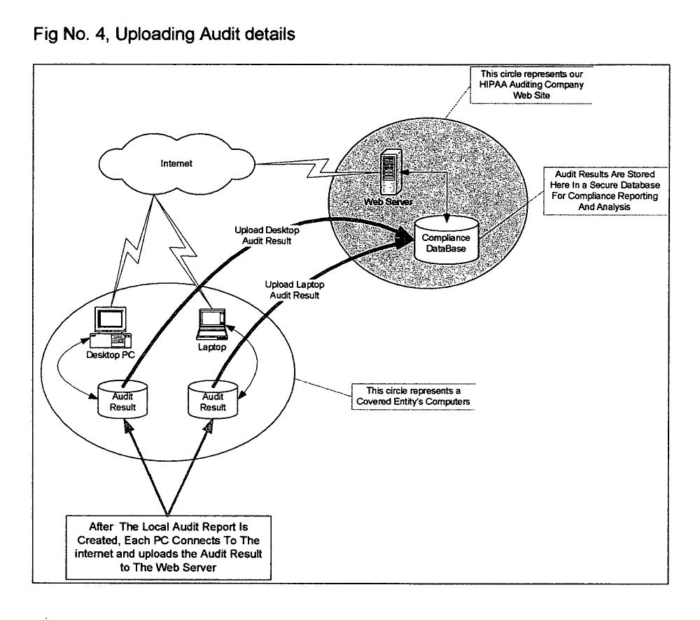

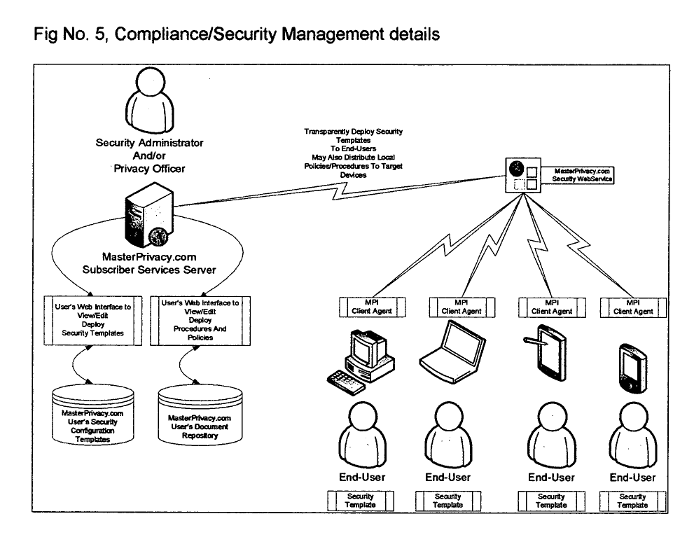

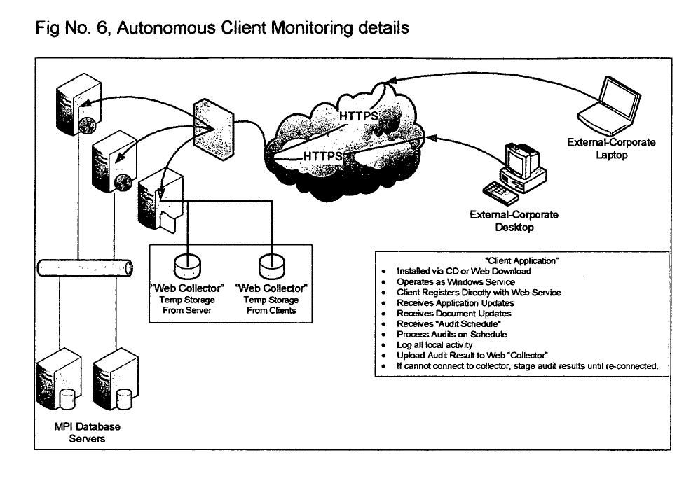

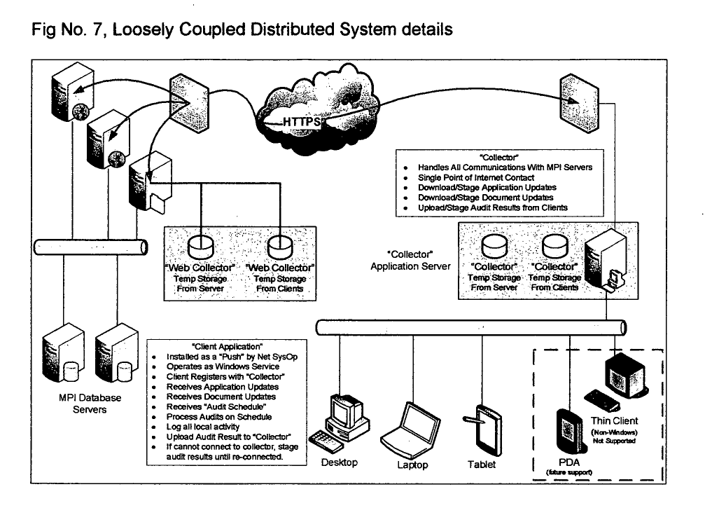

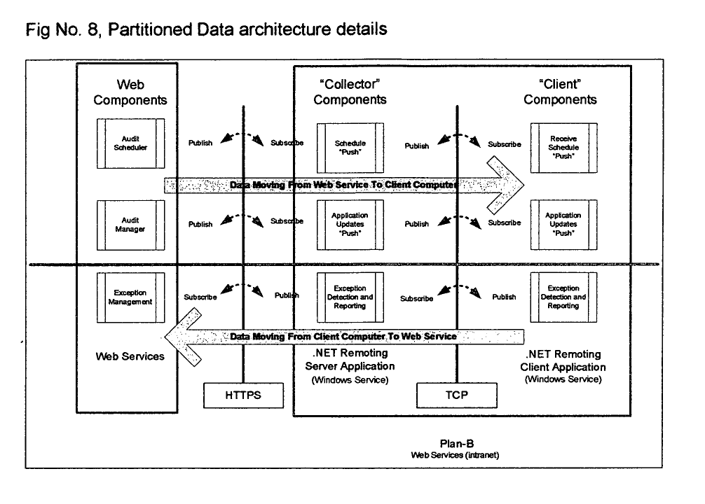

### BACKGROUND OF INVENTION

Many companies, institutions and governments have a history of problems to insure the compliance with critical functions, procedures and policies and have attempted various methods and means to insure a level of compliance. Consequences of failure to comply with said procedures or policies range from life threatening to exposure of legal liability negligence or loss of customers from failure to provide a level of customer service or attention to details.

For example, The Health Insurance Portability and Accountability Act (HIPAA) was enacted as PUBLIC LAW 104-191 on Aug. 21, 1996. Compliance standards for privacy and security were promulgated by the Department of Health and Human Services (DHHS) under the auspices of this public law. The final HIPAA Privacy Rule was published as 45 CFR Parts 160 and 164. The final HIPAA Security Rule was published as 45 CFR Parts 160, 162, and 164. These rules set forth specific standards and requirements intended to protect the privacy of healthcare consumers. The rules mandate that all organizations and individuals involved in the delivery of and/or payment for healthcare services comply with the standards and requirements as defined in the rules. The rules refer to these affected organizations and individuals as Covered Entities (CEs).

While this law has been in effect since 1996, neither state nor federal governments have an active plan to determine which CEs are complying with the law. As a result overall compliance is very poor which means CEs have a significant potential liability exposure and, perhaps more importantly, the consuming public is exposed to unnecessary risk of identity theft and other “information based” crimes.

Currently, it is impossible for the Department of Health and Human Services (DHHS) and the Office of Civil Rights (OCR) to fulfill their mandated enforcement obligation because they have neither the technical expertise or resources (people, time, money) to audit the Covered Entity population to measure and assess the national level of compliance. Under HIPAA, DHHS is effectively charged with the responsibility for managing the compliance effort nationwide. Such responsibility includes oversight of compliance levels and on-going enforcement of the regulations. The inability of DHHS and OCR to measure or assess the level of compliance of the CE population results in a shockingly poor level of CE compliance across the nation.

CEs are a serous security risk for the country and the citizens who participate in the US healthcare system. Collectively, CEs represents the largest repository of personal information in the nation. Each CE collects and stores vast quantities of personal information including: names, addresses, phone numbers, driver license numbers, social security numbers, and credit card numbers, as well as personal medical histories for storage in healthcare computer systems. By all accounts these computer systems are not adequately secured and overall have not complied with the HIPAA mandates for security and privacy. The lack of DHHS and OCR supervision and regulatory enforcement has encouraged the CE population to virtually ignore the regulations. As a result, the private and personal information of the general public is at significant risk for unauthorized disclosure and out right identity theft.

With the healthcare industry's rapid migration to “all electronic” health record systems (EHR), the previously listed risks to the public will increase by orders of magnitude. Such concentration of upersonal information” in 3.8 million mostly insecure locations make it increasingly likely that identity thieves will increasingly focus on healthcare entities as easy targets for harvesting identity information. These facts are confirmed by CERT at Carnegie Mellon University.

The result of such incomplete and ineffective implementation leaves virtually every person in the United States who receives or pays for healthcare services exposed to the significant and growing threat of identity theft resulting from unauthorized release of personal information. In addition, because the HIPAA security requirements are not widely enforced, hackers specifically target these non secure small company portals 300 percent more frequently (according to CERT) than larger well protected systems. Hackers also exploit these unsecured but “trusted” healthcare computers to spread viruses and malicious worms, which costs the Nation billions of dollars every year.

There is a significant need for a method and system for ensuring that minimum security requirements are implemented nationwide across the spectrum of CEs.

A method and system is needed to provide both the means and opportunity to systematically measure compliance levels and to ensure enforcement of predetermined critical functions as user defined and/or as mandated by laws and/or performance agreements thereby enabling consistently applied standards of operation across a service delivery network, including but not limited to financial services, healthcare, and insurance.

### SUMMARY OF THE INVENTION

The present invention provides a client installed software application that is supported by an intemet-based server application. The client application performs detailed analysis of the security configuration of the client computer system by comparing individual security settings with a “security template” distributed to the client application from the internet-based server application (or via other electronic distribution method including but not limited to any form of removable media). A registered user on of the client computer launches the Client Application and initiates the execution of the Audit process that ultimately produces a point-in-time or snap-shot comparative analysis. The results of the comparative analysis are securely stored (encrypted) on the client computer system and are available for review and action that is predetermined by the regulatory authority(s). The results of the analysis may also be transferred to the internet-based server application, using a secure communications link, for permanent storage in a secure database. The server application and database provide the means for aggregating and reporting compliance levels at any level of granularity from a single client computer to a regional, state, or national view.

Recognizing that all computers for all CEs are not continuously connected to a network (including but not limited to peer-to-peer, WIFI, LAN, WAN, private intranet, public internet), the client software application may be distributed by any electronic means including any type of removable media (such as CDROM, diskette, and flash memory). Further, the client software application does not require a network connection to perform the designed point-in-time audit function. The client application has the means to report audit results to the regulatory authority via a network connection and/or by transferring audit results to any removable media or by hardcopy report which is then sent via mail or courier to the presiding regulatory authority.

In accordance with this invention, a client installed software application and an internet-based server application are provided. The client application performs detailed analysis of the security configuration of the client computer system by comparing individual security settings with a “security template” defined and approved by the regulating authority and distributed to the client application from the intemet-based server application.

The purpose for supporting a customizable security template function is to allow a regulatory authority to define audit criteria that apply to their specific situation rather than have a generic “template” that is applied to all CEs regardless of practice, size, or complexity. Thus, a regulatory authority may define a “customized” security template that meets their specific and particular auditing requirements. Further, the security template may be modified at any time by the regulatory authority and the modified template is automatically distributed to each of the client computer systems based upon their representation in the server database. Further, the regulatory agency may create multiple security templates each containing a unique set of audit checks. Such flexibility is valuable in tailoring the content of the audit to the specific requirements that apply to a particular type of CE. For example, the audit scope or detail performed for a dentist may be differentiated from the audit of a clinical laboratory or a large public hospital or a self-insured employer.

For example, with significant and increasing amounts of personal and health data collected and stored in CE computer systems, and because these CEs are not complying with the mandate of HIPAA, an Auditing System is necessary for regulatory authorities to obtain meaningful compliance statistics and to provide an objective and powerful incentive for CE-s to bring their computer systems into compliance with applicable security requirements to ultimately achieve the goal of regulatory oversight which is protection of the rights, privacy, and safety of the consuming public.

Upon the enactment of an official Auditing System that can check each computer within each covered entity, present/invoice and collect an audit fee, and provide all scheduling of audits; compliance with the HIPAA regulations will improve dramatically throughout the CE community. As a result, the national healthcare information system that we all rely upon will be much more secure and thus will significantly reduce the risk of unauthorized disclosure of protected health information and reduce the likelihood of identity theft for all citizens.

This auditing system allows Covered Entities to be audited with respect to their compliance with mandated computer security standards established by various regulatory authorities. The purpose of such security standards is to protect of the vast amount of personal information housed in medical records that are stored electronically throughout the healthcare network.

In keeping with an “audit” function, all events occurring on both the target computer and server are logged to a secure file for future reference by the regulatory authority as a means to validate a previously generated audit.

The bifurcated design of the client and server application components also ensures an efficient, secure, and scaleable infrastructure for distributing, installing, and maintaining the Audit Client Program across a large population of computers in a geographically dispersed environment.

Provide a method and system by which regulatory authorities can compare compliance levels within and across their affected base of CEs. Compliance comparisons may be made from computer to computer or CE to CE as well as comparing the compliance level of a given CE to the state or national compliance “average” in order to gauge “peer-level” adherence to regulatory requirements. In effect, the regulatory agency can derive near-real-time metrics on the level of compliance across the entire network of CE computers. Such metrics provide the regulatory authority with unprecedented depth and breadth of knowledge regarding the consistency of compliance from CE to CE. This enables regulatory authorities to identify “pockets” of compliance issues which can then be addressed through education, training, or, as necessary, direct intervention to remediate the offending CEs compliance weaknesses which represent unwarranted vulnerabilities to the privacy and safety of the consuming public.

After the Audit, upon failure of any key compliance criteria, the client and/or server system can automatically calculate a future time and date for a re-test, schedule the re-test, print out the specific compliance issues (failures) that require remediation before the scheduled re-test, list any applicable regulatory rules that describe the compliance requirements for the specific issues identified in the audit, as well as a list of any monetary penalties that may be imposed from continued non-compliance.

Assessed penalties may be paid electronically (typically via credit card or check) from within the client auditing system through a secure network connection to the server application from which standard accounting and management reporting and review are available to designated authorized users (typically regulatory agency accounting staff).

The client auditing system reports through the server system which can interface with the applicable government regulatory system(s) that control or manage the status and issuance of professional and operating licenses for CEs so as to provide a deterrent against intentional or flagrant non compliance by preventing renewal of a license for any CE that does not meet the minimum security * standard established by the governing regulatory authority. Alternatively, the system can “feed” assessed penalties to the system(s) that manage professional and operating licenses for CEs that are subsequently included in the renewal fees payable by the affected CE.

By empowering the regulatory authorities with the ability to centrally monitor and manage security compliance across the affected network of CEs, the CEs have a powerful incentive (e.g. avoid penalties and/or loss of operating license) and an assertive means by which to measure (audit) their own computer systems with the objective of improving their level of security compliance.

### PREFERRED SYSTEM EMBODIMENT AND DESCRIPTION OF DRAWINGS

FIG. No. 1 Overview Scope of System

FIG. No. 1a, Overview of System Operations

FIG. No. 2, Install Audit Program details

FIG. No. 3, Run Audit Program details

FIG. No. 4, Uploading Audit details

FIG. No. 5, Compliance/Security Management details

FIG. No. 6, Autonomous Client Monitoring details

FIG. No. 7, Loosely Coupled Distributed System details

FIG. No. 8, Partitioned Data architecture details

Asynchronous process for requesting and installing Audit Client Program on Target Computer. Asynchronous process for requesting and performing Compliance Audit on distributed computers which may or may not be continuously connected to a network FIG. No. 1.

Begin Audit Client Program Installation Process FIG. No. 1a.

User Initiated Installation of Audit Client Program FIG. No. 2-7
Upon receipt of the email from the Server containing Unique URL
   User “clicks” on the Unique URL in the body of the email message Target computer initiates secure SSL connection to server Server responds to SSL connection request
      Unsuccessful SSL connection
         Installation requires a secure connection channel
         Terminate connection
      Successful SSL connection
         Proceed with download process
         Server extracts additional user information from
         “browser object”
         Referring URL, User Host Address, browser type & version, CLR version, Platform type & version, ActiveXControls enabled, Cookies enabled, Absolute Uri, User Agent)
         Server retrieves download request record from server database using Unique User Identifier (e.g. email address)
         Server extracts encrypted string from Unique URL passed by target computer ∝Server retrieves download request record from Server Database using Unique Download Identifier (passed in Unique URL)
         Server compares encrypted string created by Server and stored in Server Database to the encrypted string passed in the Unique URL
         If Strings do not match
         Unique URL was corrupted or has been altered in transport
         Terminate download
         If Strings match
         Proceed with download
         Server records download request initiated in server database
         Server initiates download of specified
         Audit Client program to Target Computer
         User on Target Computer is prompted to install, save, or cancel download
         Install
         Program is downloaded to a temporary folder on Target Computer Upon completion of download, the installer package is validated by the Windows Installer
         If Installer package not valid—terminate installation If Installer Package is valid—launch Windows Installer

Windows Installer performs a standard installation of the Audit Client Program as a Windows application
If unsuccessful Windows Install
   Notify user of error(s)
   Terminate installation
If successful Windows Install
   Launch Audit Client Program with default corifiguration
   Upon launch of Audit Client Program
   Check for internet connection
      If no internet connection
         Check for last time update was performed
         If interval exceeds predefined threshold, prompt user with warning that local files may be out of date
         If user accepts update now option and they establish an internet connection (dial-up or direct) then proceed with update check.
         If user rejects update now option, provide second warning that local files may be out of date.
         If user rejects second warning, terminate the update check and unlock user interface
      If Internet connection available
         “Lock” Audit Client Program user interface during this update process
         (i.e. user may not access the Program until the update is completed).
         Contact web update service to obtain updates to Audit Client Program local files
         If updates are available,
         Audit Client Program initiates a download request with Server
         Server receives update-download request Server retrieves “Workstation Object” from server database using unique Computer Identifier passed in the update-download request Audit Client Program
         Server determines which, if any, downloads are appropriate for the requesting Target Computer.
         Based upon subscription services purchased,
         Target Machine may receive a variety of files containing compliance and regulatory requirements as they pertain to this Target Computer (e.g. role, function, responsibility, requesting user, CE, business associate, patient, etc.)
         As the granularity of this process can be as specific as a particular “user” with a particular “computer”, the content of updates may be tailored to the specific auditing requirements of this combination.

End of Audit Client Program Installation Process

Audit Activity and data storage FIG. No. 1 and FIG. No. 8
Analyze computer system configuration using integrated “security templates”
Store analysis results in secure form to prevent tampering with results (audit integrity)
Format analysis results in “drill-down” format to facilitate user navigation through lengthy analysis results.
Store reports by date/time
Provide means to export audit report results to spreadsheet format (e.g. Microsoft Excel) to facilitate import into other documents, reports, project plans, etc.
Provide means to view “high-level” summary of audit results in bar-chart format
Provide means to compare any two audit reports highlighting differences between them
Map audit results to applicable HIPAA Security Rule (or other regulatory rules/laws) section/paragraph
Present audit results in “Red-Yellow-Green” stoplight format to indicate acritical” “warning” and “compliant” status for each audit check performed
Assign numerical score to each audit result to facilitate grouping of results into Red-Yellow-Green summary format
Self-Updating/Self Maintaining: Self-Updating support tables at Client Application start-up (synchronous update—help files, antivirus, SpyWare, security checks, messages, etc.)
Integrated messaging facility to permit user to send messages to Customer Support Server without using standard “email” services. Automatically creating a one-step trouble ticket
   Government Compliance Audit
Analyze computer system configuration using integrated “security templates”
Store analysis results in secure form to prevent tampering with results (audit integrity)
Map audit results to applicable HIPAA Security Rule section/paragraph or other customer defined systems requirements.

What is claimed is:

1. A system for monitoring, auditing and flagging exceptions or compliance issues comprising the following process steps and apparatus:
a. A computer processor means for identifying and tracking a plurality of business processes and comparative data requirements, and
b. computer storage means for storing data on a storage medium, and
c. a first executable method for processing comparative data for matching required entries and their parameters and for flagging specified exceptions, inconsistencies and anomalies to a secondary portion of said storage medium or history log files, and
d. a second executable method and means for output of the data and exception reports as required on the local computer processor or by authorized LAN or WAN remote access, and
e. a means of providing security of data and allowing local and LAN or WAN remote access or query of said data to only pre-authorized servers or personnel, and

2. The system of claim 1, wherein a means to upload updated versions of the executables and new system requirement specifications and data reporting fields can be accomplished either manually or automatically locally or by remote server, and

3. The system of claim 1, wherein a means to apply a time and date stamp on the data, compliance status, exceptions, system network configuration, identity and number of computers and access log files, and

4. The system of claim 1, wherein a means to apply history log files for a plurality of data fields for checking user defined fields, ISO-9000 fields or HIPPA fields or other critical system function fields including but not limited to fields such as;

| | | |
|---|---|---|
| 1 | Anti Virus | |
| 2 | | Anti Virus Product Installed |
| 3 | | Anti Virus Product Configuration |
| 4 | | Anti Virus Running Tasks |
| 5 | Data Backup | |
| 6 | | Number of Drives To Scan |
| 7 | | Number of Drives Scanned |
| 8 | | Number of Fixed Media Devices |
| 9 | | Number of Removable Media Devices |
| 10 | | Number of File Folders |
| 11 | | Number of Files |
| 12 | | Number of System and Application Program |
| | | Files |
| 13 | | Number of “User” Files |
| 14 | | Number of Encrypted Files |
| 15 | | Number of “User” Files Never Backed-Up |
| 16 | | Number of “User” Files Changed Since |
| | | Back-Up |
| 17 | | Number of “User” Files Changed Today |
| 18 | | Number of “User” Files to Back-Up Tonight |
| 19 | File Security | |
| 20 | | Device Network Shares |
| 21 | Registry Keys | |
| 22 | | Windows Registry Hive “CLASSES_ROOT” |
| 23 | | Users |
| 24 | | Machine |
| 25 | Security Policy | |
| 26 | | Sample Applications |
| 27 | | Parent Paths |
| 28 | | IIS Logging Enabled |
| 29 | | Local Account Password Test |
| 30 | | Windows File System |
| 31 | | Windows File System |
| 32 | | Password Expiration |
| 33 | | User Has Administrator Authority |
| 34 | | Internet Connection Firewall |
| 35 | | Windows Services |
| 36 | | Minimum Password Length |
| 37 | | Minimum Password Age |
| 38 | | Require Logon To Change Password |
| 39 | | Number of Failed Login Attempts before |
| | | User Account is Locked Out |
| 40 | | Force Windows User LogOff outside of |
| | | scheduled working hours |
| 41 | | New Administrator Name |
| 42 | | New Guest Name |
| 43 | | Enable Admin Account |
| 44 | | Reset User Account Lockout Count |
| 45 | | Set Time/Duration How Long is Locked-Out |
| | | Account Disabled |
| 46 | | Maximum Log Size |
| 47 | | Audit Log Retention Period |
| 48 | | Maximum Log Size |
| 49 | | Audit Log Retention Period |
| 50 | | Retention Days |
| 51 | | Maximum Log Size |
| 52 | | Audit Log Retention Period |
| 53 | | Audit Windows User Logon Events |
| 54 | | Audit Privilege Use |
| 55 | | Audit Changes Made to Windows Policies |
| 56 | | Audit Changes Made to Windows User |
| | | Accounts |
| 57 | | Audit Access Attempts to Windows |
| | | Directory Services |
| 58 | | Audit Windows User Logon Attempts |
| 59 | | Remove Option |
| 60 | | Windows “clt-alt-del” Disabled (i.e. If |
| | | enabled, Windows User Login is NOT |
| | | Required) |
| 61 | | Permit Laptop to Undock Without Logon |
| 62 | | Incompatibility Level |
| 63 | | LAN Manager Hash Not Required |
| 64 | | Restrict Anonymous |
| 65 | | Authority to Add Printer Drivers |
| 66 | | enable security signature |
| 67 | | Require Digital Signature or Digital Seal |
| 68 | | Parameters |
| 69 | | Refuse Password Change |
| 70 | | Null Session Shares |
| 71 | | Null Session Pipes |
| 72 | | Windows Batch Submit Authority |
| 73 | | No Default Admin Owner |
| 74 | | Force Guest |
| 75 | | FIPS Algorithm Policy |
| 76 | | Allow Windows Shutdown Without Logon |
| 77 | | Macro Security |
| 78 | Security Updates | |
| 79 | | Security Updates for Windows |
| 80 | | Microsoft Windows NT 4.0 |
| 81 | | Microsoft Windows 2000 |
| 82 | | Microsoft Windows XP |
| 83 | | Microsoft Windows Server 2003 |
| 84 | | Microsoft Internet Information Server (IIS) |
| 85 | | Microsoft SQL Server |
| 86 | | Microsoft Exchange Server 2003 |
| 87 | | Microsoft BizTalk Server 2000, 2002, and |
| | | 2004 |
| 88 | | Microsoft Commerce Server 2000 and 2002 |
| 89 | | Microsoft Content Management Server 2001 |
| | | and 2002 |
| 90 | | Microsoft Host Integration Server 2000, 2004 |
| 91 | | Microsoft SNA Server 4.0 |
| 92 | | Microsoft Windows Components |
| 93 | | Microsoft Data Access Components (MDAC) |
| 94 | | Microsoft Data Access Components |
| | | (MDAC) 2.5, 2.6, 2.7, and 2.8 |
| 95 | | Microsoft Virtual Machine |
| 96 | | MSXML 2.5, 2.6, 3.0, and 4.0 |
| 97 | | Internet Connection Firewall configuration |
| | | check |
| 98 | | Automatic Updates configuration check |
| 99 | | IE zone configuration checks (including |
| | | custom) |
| 100 | | IE Enhanced Security Configuration checks |
| | | for Windows Server 2003 |
| 101 | | Microsoft Access 2000 |
| 102 | | Microsoft Access 2000 Runtime |
| 103 | | Microsoft Access 2002 |
| 104 | | Microsoft Access 2002 Runtime |
| 105 | | Microsoft Access 2003 |
| 106 | | Microsoft Access 2003 Runtime |
| 107 | | Microsoft Business Contact Manager for |
| | | Outlook 2003 |
| 108 | | Microsoft Excel 2000 |
| 109 | | Microsoft Excel 2002 |
| 110 | | Microsoft FrontPage 2002 |
| 111 | | Microsoft FrontPage 2003 |
| 112 | | Microsoft FrontPage ® 2000 |
| 113 | | Microsoft InfoPath 2003 |
| 114 | | Microsoft Internet Explorer |
| 115 | | Microsoft Visio 2002 |
| 116 | | Microsoft Office Web Components 2000 |
| 117 | | Microsoft Office Web Components 2002 |
| 118 | | Microsoft Office Web Components 2003 |
| 119 | | Microsoft OneNote ® 2003 |
| 120 | | Microsoft Outlook ® 2002 |
| 121 | | Microsoft Outlook ® 2003 |
| 122 | | Microsoft Outlook ® 2000 |
| 123 | | Microsoft PhotoDraw ® 2000 |
| 124 | | Microsoft PowerPoint ® 2002 |
| 125 | | Microsoft PowerPoint ® 2003 |
| 126 | | Microsoft PowerPoint ® 2000 |
| 127 | | Microsoft Project ® 2002 |
| 128 | | Microsoft Project ® 2003 |
| 129 | | Microsoft Publisher ® 2000 |
| 130 | | Microsoft Publisher ® 2002 |
| 131 | | Microsoft Publisher ® 2003 |
| 132 | | Microsoft Visio ® 2003 |
| 133 | | Microsoft Word ® 2000 |
| 134 | | Microsoft Word ® 2002 |
| 135 | | Microsoft Word ® 2003 |
| 136 | | Microsoft Works ® Suite 2000, 2001, 2003 |
| 137 | | Windows Media Player |
| 138 | SpyWare | |
| 139 | | SpyWare Memory Scan |
| 140 | | SpyWare Registry Scan |
| 141 | | SpyWare Program Scan |
| 142 | | SpyWare Cookie Scan |
| 143 | User Rights | |
| 144 | | Users UserGroup |
| 145 | | Guests UserGroup |
| 146 | | Administrators UserGroup |
| 147 | | Network Logon Right |
| 148 | | Tcb Privilege |
| 149 | | Machine Account Privilege |
| 150 | | Backup Privilege |
| 151 | | Change Notify Privilege |
| 152 | | Windows System Time Privilege (allowed to |
| | | change system time) |
| 153 | | Create Pagefile Privilege |
| 154 | | CreateToken Privilege |
| 155 | | Create Permanent Privilege |
| 156 | | Debug Privilege |
| 157 | | Remote Shutdown Privilege |
| 158 | | Audit Privilege |
| 159 | | Increase Quota Privilege |
| 160 | | Increase Base Priority Privilege |
| 161 | | Load Driver Privilege |
| 162 | | Lock Memory Privilege |
| 163 | | Batch Logon Right |
| 164 | | Windows Service Logon Right |
| 165 | | Interactive Logon Right |
| 166 | | Security Privilege |
| 167 | | Windows System Environment Privilege |
| | | (allowed to modify Windows environment) |
| 168 | | Profile Single Process Privilege |
| 169 | | Windows System Profile Privilege |
| | | (allowed to change user profile) |
| 170 | | Assign Primary Token Privilege |
| 171 | | Restore Privilege |
| 172 | | Windows Shutdown Privilege |
| 173 | | Windows User Allowed to “Take |
| | | Ownership” of a Resource (e.g. file, folder) |
| 174 | | Deny Network Logon Right |
| 175 | | Deny Batch Logon Right |
| 176 | | Deny Service Logon Right |
| 177 | | Deny Interactive Logon Right |
| 178 | | Laptop “Undock” Privilege |
| 179 | | Windows SyncAgent Privilege (Intelli-mirror) |
| 180 | | Enable Delegation Privilege |
| 181 | | Manage Volume Privilege |
| 182 | | Remote Interactive Logon Right |
| 183 | | Deny Remote Interactive Logon Right |

and

5. The system of claim 1 and claim 4, wherein a system compliance status can be checked or simulated prior to going live on the network or submission to internal or external auditing regulatory bodies or agencies for gap system analysis and system deficiency reporting and corrective action, and

6. The system of claim 5, wherein resulting system violations or exceptions can be displayed visually or printed to a user or systems administrator, and

7. The system of claim 1, wherein said system is useable remotely by having means to transmit data to a central processing computer located elsewhere by data communications means and means for returning the processed data, and

8. The means of claim 1 whereby an interface with other remote communication devices can be immediately notified or integrated.
